(19) United States
(12) Patent Application Publication
(10) Pub. No.: US 2013/0088905 A1
(43) Pub. Date: Apr. 11, 2013

(54) DEAD-TIME COMPENSATION ALGORITHM FOR 3-PHASE INVERTER USING SVPWM

(71) Applicants: Dong Hee LEE, Busan (KR); Hong Min KIM, Tongyeong-si (KR)

(72) Inventors: Dong Hee LEE, Busan (KR); Hong Min KIM, Tongyeong-si (KR)

(73) Assignees: AUTO POWER CO., LTD., Busan (KR); KYUNGSUNG UNIVERSITY INDUSTRY COOPERATION FOUNDATION, Busan (KR)

(21) Appl. No.: 13/295,146

(22) Filed: Nov. 14, 2011

(30) Foreign Application Priority Data
Oct. 5, 2011 (KR) 10-2011-0101087

(51) Int. Cl. H02M 7/537

(52) U.S. Cl. 363/131

(57) ABSTRACT

Disclosed is a dead-time compensation method of a 3-phase inverter using an SVPWM scheme. The dead-time compensation method includes generating a switching signal having dead-time with respect to the power semiconductor switches of the upper and lower arms in order to obtain a predetermined output through the SVPWM scheme, detecting medium phase current from each phase current output through the switching signal, determining polarity of the medium phase current, and generating a switching signal by calculating switching time in order to compensate for time to apply effective voltage according to the polarity of the medium phase current. Through the dead-time compensation method, the distortion of the output voltage and the reduction of voltage having a fundamental wave in the output voltage, which are caused by the dead-time, are minimized through the switching of compensating for the time to apply effective voltage based on the polarity of the load current.

### BACKGROUND OF THE INVENTION

1. Field of the Invention

The present invention relates to a simple dead-time compensation algorithm for a 3-phase inverter using an SVPWM (Space Vector Pulse Width Modulation) scheme. In more particular, the present invention relates to a simple dead-time compensation algorithm for a 3-phase inverter using an SVPWM scheme, capable of minimizing the distortion of output voltage and the discontinuity of current when the polarity of phase current is switched, by compensating for dead-time applied in order to prevent arm-short between semiconductor switches of upper and lower arms when an electric motor is controlled by using a 3-phase SUPWM inverter based on semiconductor switches.

2. Description of the Related Art

Recently, as characteristics of power semiconductor switches are improved, and the switching technology thereof has been gradually developed, the performance of a power transformer is improved. Accordingly, the use of a voltage source inverter has been rapidly increased in the field of an electric motor occupying 70% of the power consumed in industrial settings.

In particular, actually, the 3-phase inverter including the power semiconductor switches has employed PWM schemes in order to control current applied to a load. Among them, an SVPWM scheme is employed to suppress switching noise of current by effectively arranging zero voltage switching sections.

The PWM scheme in which time to apply gate pulses is directly calculated has been extensively used in terms of superior harmonic characteristics, fixed switching frequencies, and the facilitation of realization.

Examples of the above technology are disclosed in following patent references 1 and 2.

In other words, patent reference 1 discloses a method of driving a 3-phase motor including determining a voltage vector section applied to each phase of a 3-phase motor, determining if the voltage vector section is in an effective range, finding the minimum value within an effective range from a terminal point of the voltage vector if the voltage vector is not in the effective range, modulating the voltage vector by performing an adding operation or a subtraction operation for the minimum value, and compensating the modulated voltage vector by the minimum value.

In addition, patent reference 2 discloses a pulse width modulation scheme based on a space voltage vector scheme.

However, the difference between time to apply effective voltage, which is issued from the controller, and time to actually apply the effective voltage to a load is made due to dead-time applied in order to prevent an arm-short between power semiconductor switches. In addition, if the direction of load current is not taken into account, voltage having a fundamental wave may be actually reduced from the output voltage applied to the load. In particular, such an influence is increased in the system requiring low voltage, so that the control performance may be degraded.

### CITED REFERENCES

Patent reference 1: Korean Patent Registration No. 0725504 (issued on 30 May, 2007)
Patent reference 1: Korean Patent Registration No. 0168807 (issued on 7 Oct., 1998)

### SUMMARY OF THE INVENTION

Accordingly, the present invention has been made keeping in mind the above problems occurring in the related art, and an object of the present invention is to provide a simply dead-time compensation algorithm of a 3-phase inverter using an SVPWM scheme, capable of minimizing the distortion of output voltage and the reduction of voltage having a fundamental wave in the output voltage, which are caused by dead-time, by taking into account the polarity of the load current.

In order to accomplish the above object according to one aspect of the present invention, there is provided a simple dead-time compensation method of a 3-phase inverter using an SVPWM scheme and having upper and lower arms including power semiconductor switches. The dead-time compensation method includes generating a switching signal having dead-time with respect to the power semiconductor switches of the upper and lower arms in order to obtain a predetermined output through the SVPWM scheme, detecting medium phase current from each phase current output through the switching signal, determining polarity of the medium phase current, and generating a switching signal by calculating switching time in order to compensate for time to apply effective voltage according to the polarity of the medium phase current.

In addition, according to the dead-time compensation method of the 3-phase inverter using the SVPWM scheme, in the determining the polarity of the medium phase current, a current magnitude range is set at a point at which a magnitude of a medium phase command voltage becomes lower than a degree of voltage drop occurring in the power semiconductor switch or an inverse diode, a normal direction of the medium phase current is detected if a magnitude of the medium phase current exceeds the current magnitude range, and a direction of the medium phase current is reversed at a prior time point if the magnitude of the medium phase current is within the current magnitude range, so that an influence is minimized at a section where effective time is overlapped with dead-time.

In addition, according to the dead-time compensation method of the 3-phase inverter using the SVPWM scheme, an effective voltage switching time is compensated by using a maximum phase value and a minimum phase value from command voltage of each phase according to a path of the medium phase current

As described above, according to the simple dead-time compensation algorithm of the 3-phase inverter using the SVPWM scheme, the distortion of the output voltage and the reduction of voltage having a fundamental wave in the output voltage, which are caused by the dead-time, may be minimized through the switching of compensating for the time to apply effective voltage based on the polarity of the load current.

### BRIEF DESCRIPTION OF THE DRAWINGS

FIG. 1 is a circuit diagram showing the structure of a typical 3-phase inverter;

FIG. 2 is a timing diagram showing an ideal SVPWM (Space Vector Pulse Width Modulation) signal of the 3-phase inverter;

FIG. 3 is a timing diagram showing an SVPWM signal into which dead-time is inserted for the purpose of explaining a simple dead-time compensation algorithm of the 3-phase inverter using an SVPWM scheme according to the present invention;

FIG. 4 is a graph showing the selection of the maximum phase and the minimum phase of 3-phase voltage according to a rotational angle in the simple dead-time compensation algorithm of the 3-phase inverter using the SVPWM scheme according to the present invention;

FIGS. 5a to 5f are circuit diagrams showing the operating mode and the current path of the 3-phase inverter of FIG. 3 when the medium phase current i_{mid}>0;

FIGS. 6a to 6f are circuit diagrams showing the operating mode and the current path of the 3-phase inverter of FIG. 3 when the medium phase current i_{mid}<0;

FIG. 7a is a graph showing a current direction in an alternating section of the medium phase current i_{mid} when the medium phase command voltage V_{mid}*>0;

FIG. 7b is a graph showing a current direction in the alternating section of the medium phase current i_{mid} when the medium phase command voltage V_{mid}*<0;

FIG. 8a is a view showing a simulation result in the ideal case without the dead-time;

FIG. 8b is a view showing a simulation result when the dead-time is 4 μs;

FIG. 8c is a view showing a simulation result when the dead-time is compensated;

FIG. 8d is a view showing a simulation result of the SVPWM scheme based on the current direction according to the present invention;

FIG. 9a is a view showing a simulation result when the dead-time is not compensated;

FIG. 9b is a view showing the simulation result when the dead-time is compensated; and

FIG. 9c is a view showing the simulation result of the SVPWM scheme based on the current direction according to the present invention.

### DETAILED DESCRIPTION OF THE INVENTION

The above object, other objects, and new features of the present invention will be more apparently comprehended with reference to the following description when taken in conjunction with the accompanying drawings.

Hereinafter, the structure according to the present invention will be described with reference to accompanying drawings.

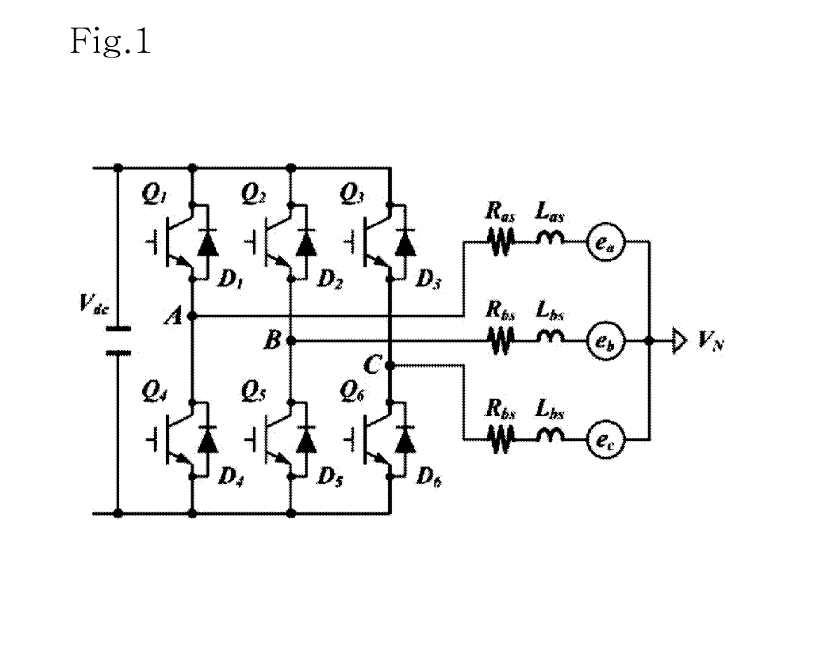

FIG. 1 is a circuit diagram showing the structure of a typical 3-phase inverter.

As shown in FIG. 1, in the 3-phase inverter, phases include power semiconductor switch transistors Q₁ to Q₆ of upper and lower arms (hereinafter, upper and lower power semiconductor switch transistors). In addition, phases A, B, and C are represented by using the power semiconductor switch transistors Q₁ and Q₄, the power semiconductor switch transistors Q₂ and Q₅, and the power semiconductor switch transistors Q₃ and Q₆, respectively, in which each pair of switch transistors have a series-connection.

In addition, the power semiconductor switch transistors Q₁ to Q₆ are provided therein with inverse diodes D₁, D₂, D₃, D₄, D₅, and D₆, respectively.

In addition, the phases A, B, and C may be connected with phase terminals of a 3-phase motor (electric motor) equipped with a stator including a resistor and an inductor and an internal rotor, and connected with an external power terminal Vdc between the power semiconductor switch transistors Q₁ and Q₄.

Meanwhile, for example, a current detector (not shown) may be provided between the external power terminal Vdc and the power semiconductor switch transistor Q₄ to detect exciting phase current supplied from the 3-phase inverter to the 3-phase motor, and a controller (not shown) may be provided to switch the power semiconductor switch transistors Q₁ to Q₆ of the 3-phase inverter, or selectively switch the power semiconductor switch transistors Q₁ to Q₆ based on the current detected from the current detector.

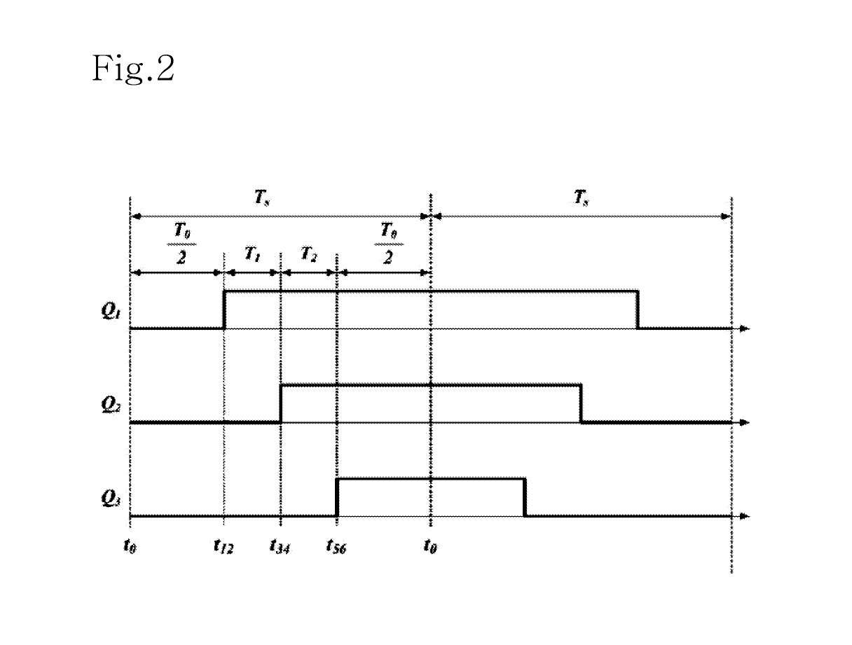

FIG. 2 is a timing diagram showing an ideal SVPWM (Space Vector Pulse Width Modulation) signal of the 3-phase inverter.

As shown in FIG. 2, a switching signal generated from the controller is applied to the upper power semiconductor switch transistors Q₁, Q₂, and Q₃, so that the switching operation is performed. Accordingly, power is supplied to the 3-phase motor.

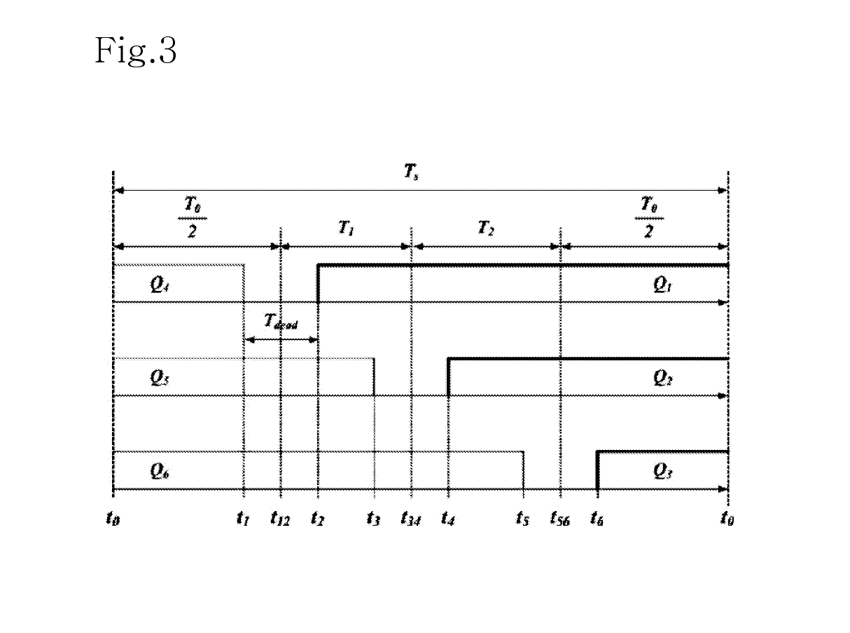

FIG. 3 is a timing diagram showing an SVPWM signal into which dead-time is inserted for the purpose of explaining a simple dead-time compensation algorithm of the 3-phase inverter using an SVPWM scheme according to the present invention.

As shown in FIG. 3, when controlling SVPWM, in order to prevent the arm-short between the upper and lower power semiconductor switch transistors, the dead-time is inserted between turn-on times of the upper and lower power semiconductor switch transistors. In addition, a time section is divided into t₀ to t₆ according to the switching time intervals and dead-time intervals, a time section T1 represents a section at which upper power semiconductor switch transistors of one phase are turned on, and lower power semiconductor switch transistors of two phases are turned on, and a time section T2 represents a section at which upper power semiconductor switch transistors of two phases are turned on, and a lower power semiconductor switch transistor of one phase is turned on.

In this case, among the power semiconductor switch transistors of three phases, the power semiconductor switch transistors of one phase receive effective voltage during the longest time so that the maximum voltage is applied, and the power semiconductor switch transistors of another phase receives zero-voltage so that the minimum voltage is applied.

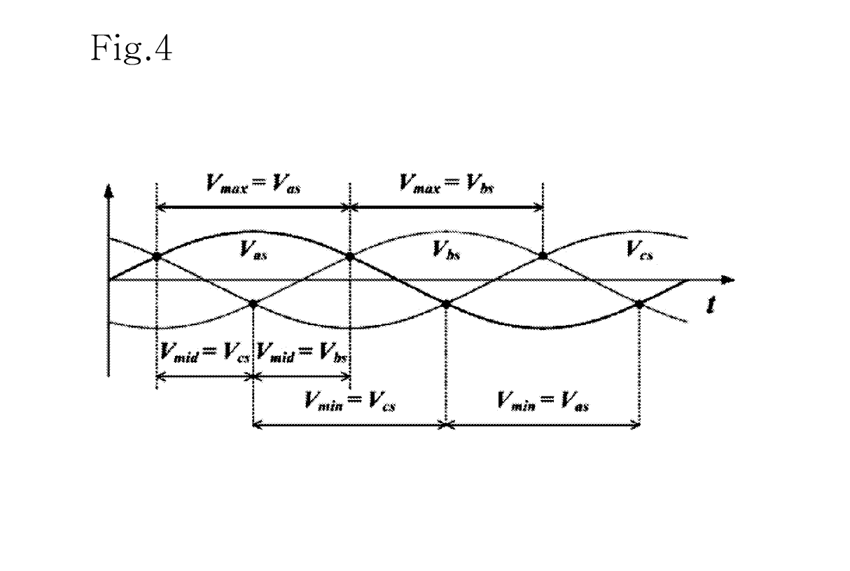

FIG. 4 is a graph showing the selection of the maximum phase and the minimum phase of 3-phase voltage according to a rotational angle in the simple dead-time compensation algorithm of the 3-phase inverter using the SVPWM scheme according to the present invention.

As shown in FIG. 4, when the 3-phase voltage is applied, each phase is alternately changed to the maximum phase Vₘₐₓ, the medium phase V_{mid}, and the minimum phase Vₘᵢₙ with time. If the maximum phase Vₘₐₓ is the A phase, the turn-on time of the upper power semiconductor switch transistor Q₁ to drive the A phase is determined by the summation T1 and T2, at which effective voltage is applied, and T0/2, at which zero-voltage is applied.

The maximum phase Vₘₐₓ the medium phase V_{mid}, and the minimum phase Vₘᵢₙ refer to the maximum phase voltage, the medium phase voltage, and the minimum phase voltage of 3-phase voltage, respectively, according to the rotational angle, and correspond to the maximum phase current iₘₐₓ the medium phase current i_{mid}, and the minimum phase current iₘᵢₙ, respectively.

In more detail, between a first point, at which voltage Vas interconnects with voltage Vcs, and a second point, at which voltage Vbs interconnects with the voltage Vcs, the maximum phase voltage Vₘₐₓ=the voltage Vas, the medium phase voltage V_{mid}=the voltage Vcs, and the minimum phase voltage Vₘᵢₙ=the voltage Vbs. Similarly, between the second and third points at which the phase voltages interconnect with each other, the maximum phase voltage Vₘₐₓ=the voltage Vas, the medium phase voltage V_{mid}=the voltage Vbs, and the minimum phase voltage Vₘᵢₙ=the voltage Vcs.

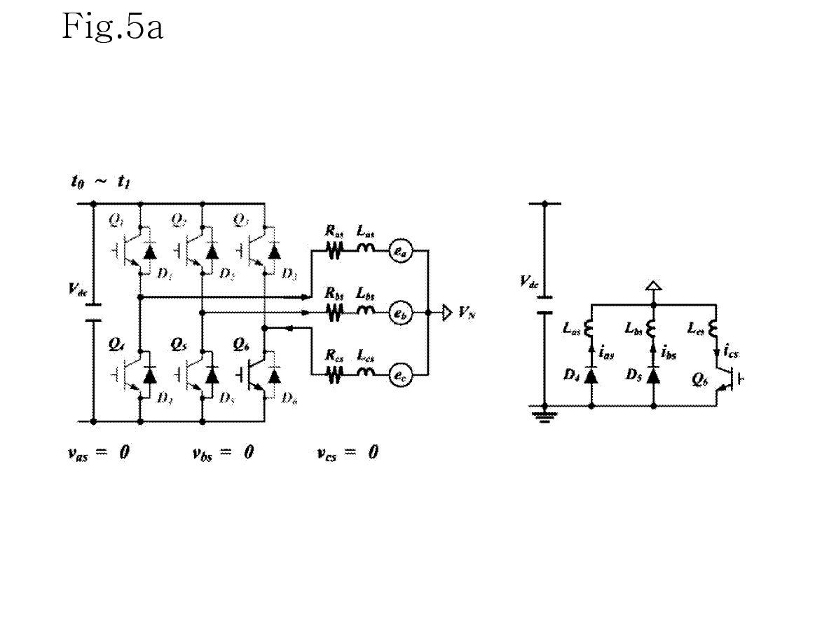

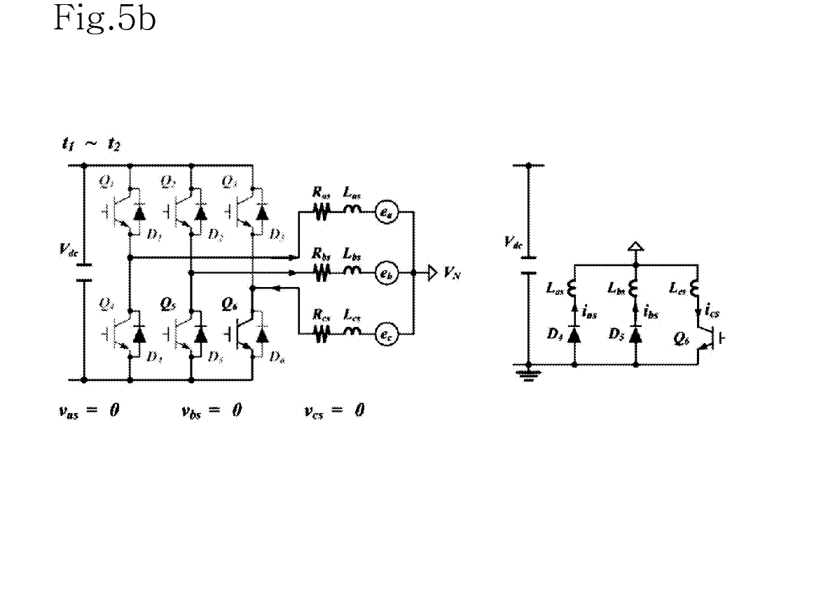

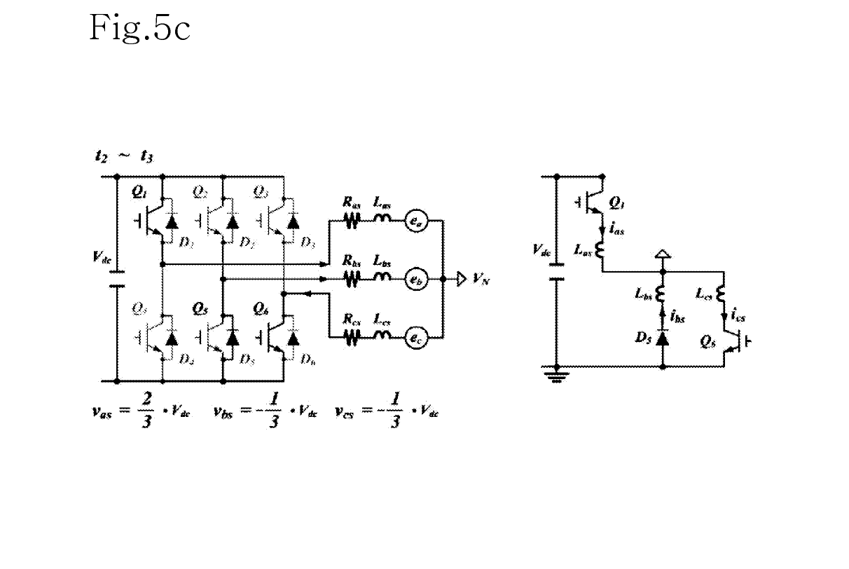

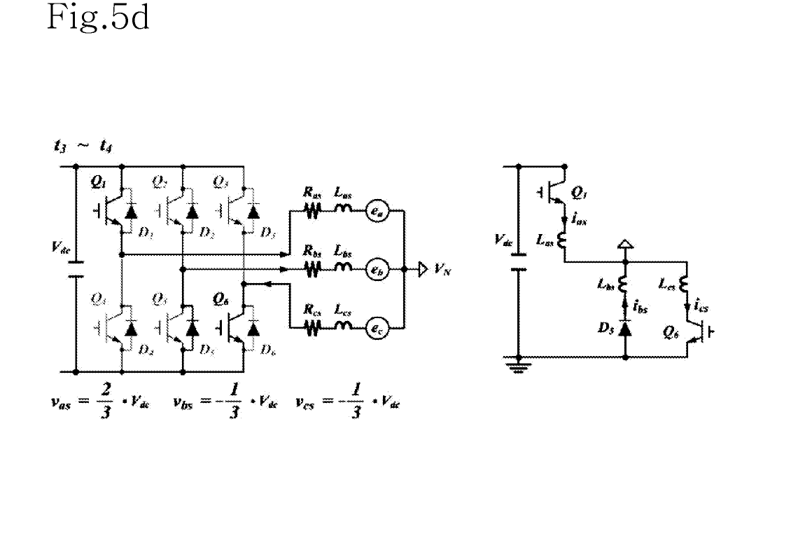

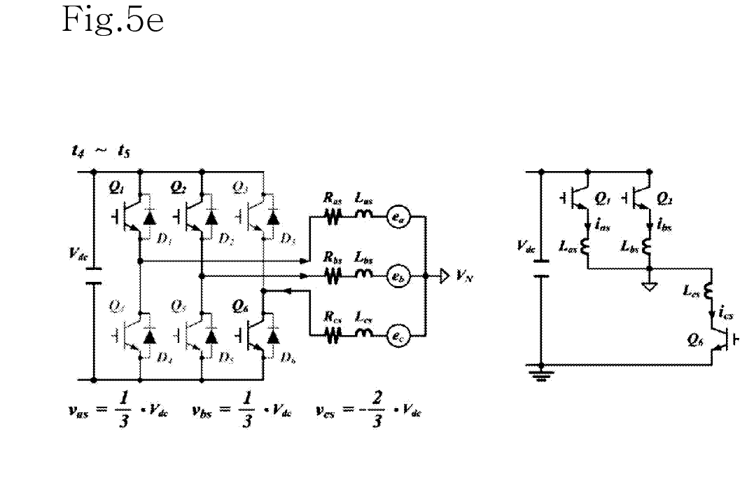

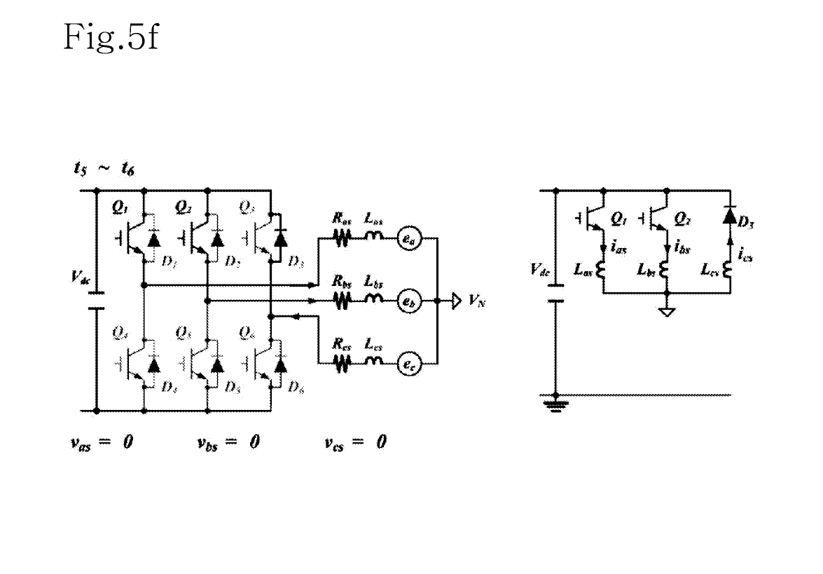

FIGS. 5a to 5f are circuit diagrams showing the operating mode and the current path of the 3-phase inverter of FIG. 3 when the medium phase current i_{mid}>0.

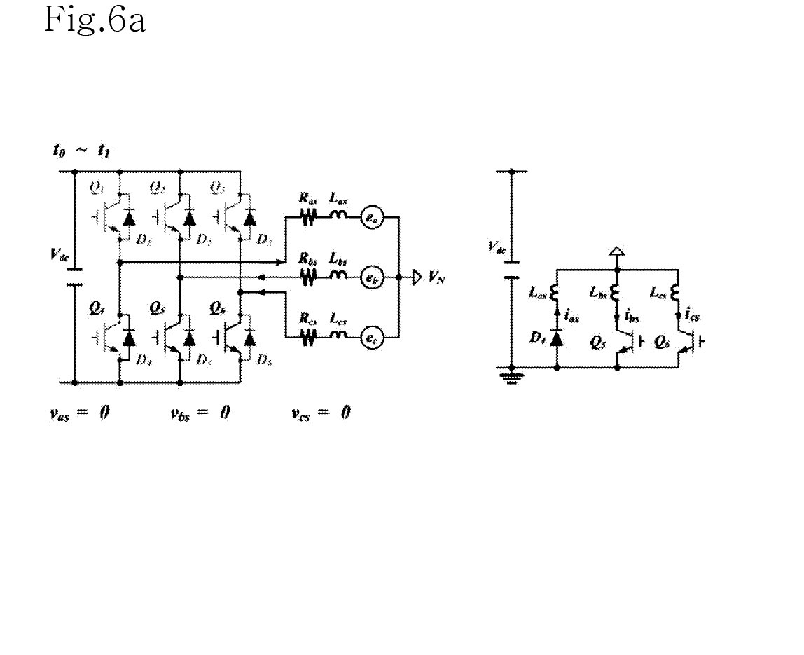

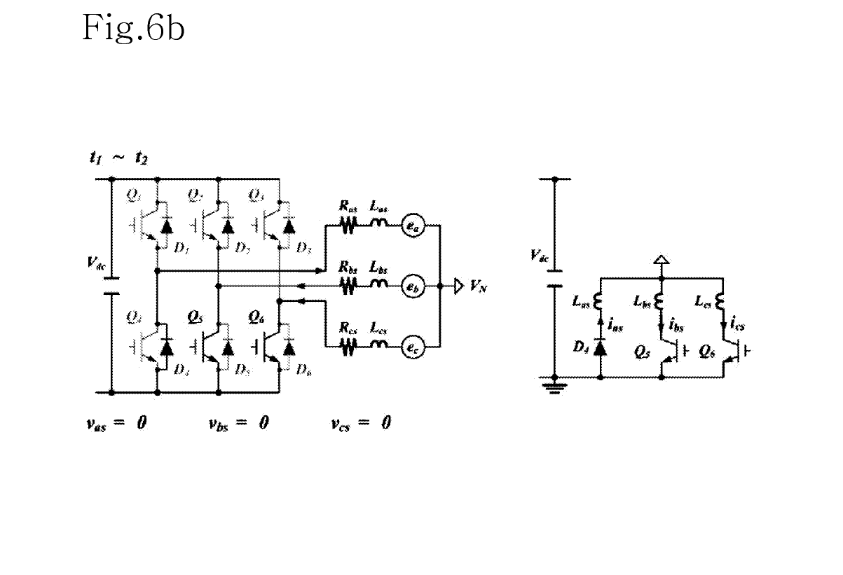

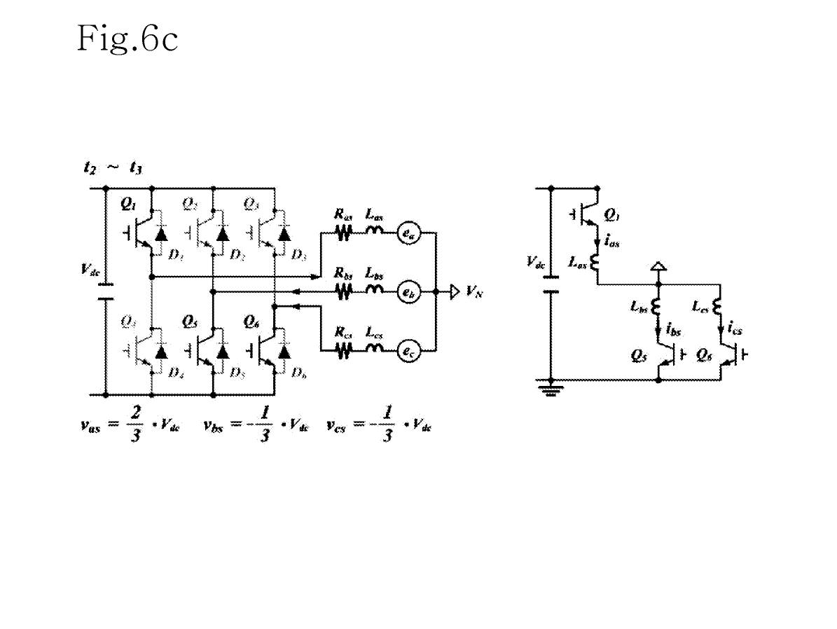

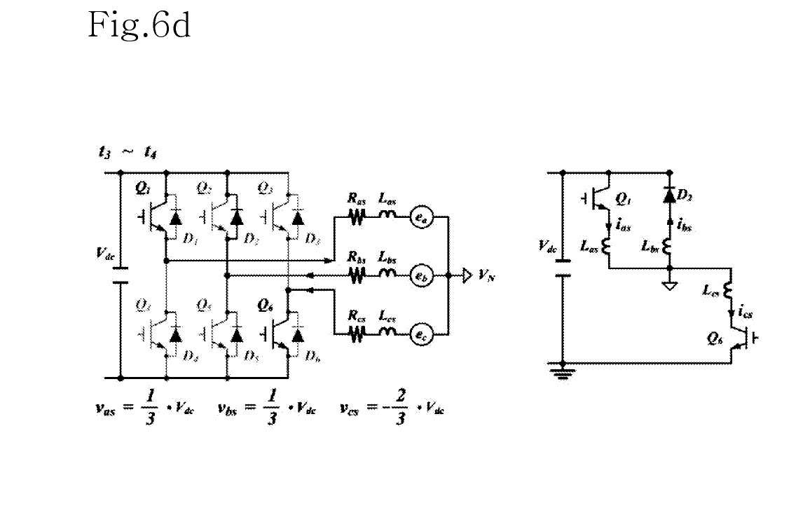

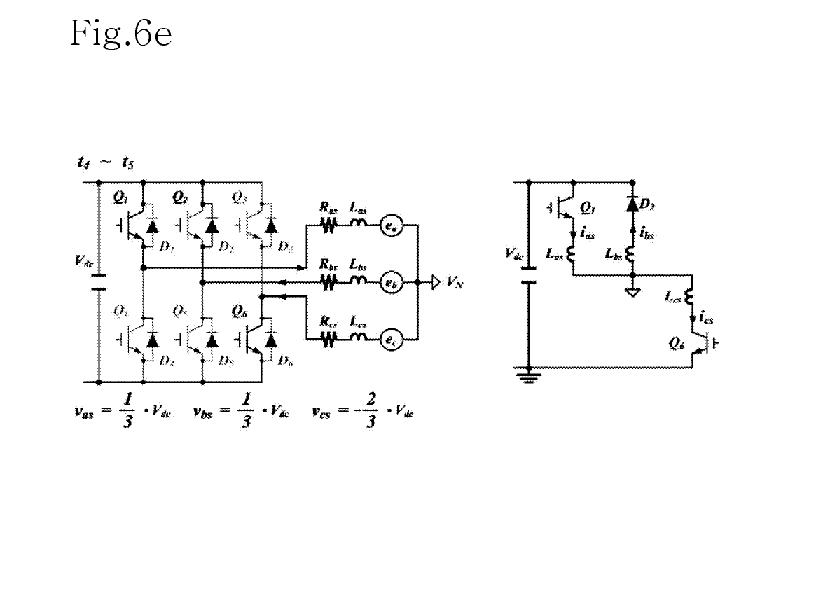

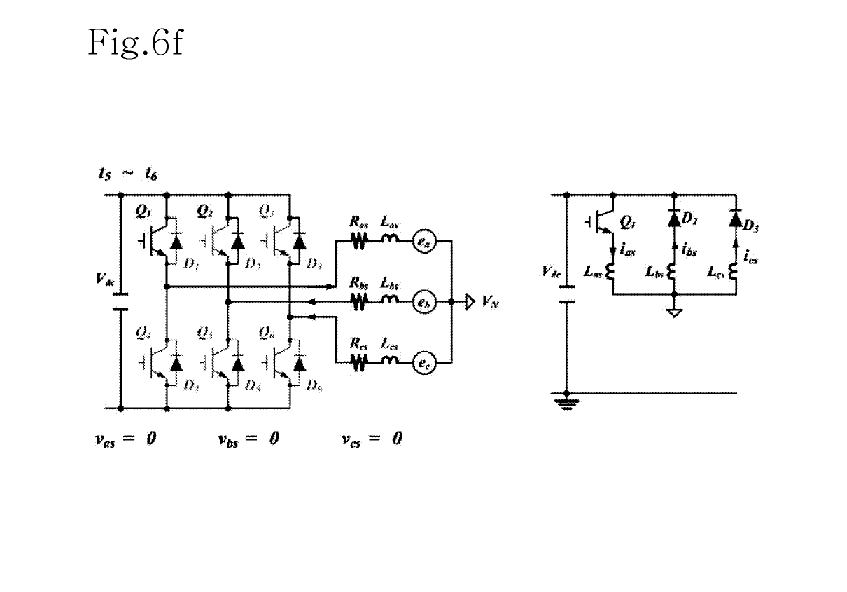

FIGS. 6a to 6f are circuit diagrams showing the operating mode and the current path of the 3-phase inverter of FIG. 3 when the medium phase current i_{mid}<0.

As shown in FIGS. 5a to 6f, a time section is divided into t₀ to t₆ according to switching time intervals and dead-time intervals, so that six operating modes are obtained. The phase voltages according to the operating modes are determined by an effective voltage vector and a zero voltage vector.

In addition, in order to mark dead-time sections, the power semiconductor switch transistors Q₁ to Q₆ are expressed in gray color.

As shown in FIGS. 3 and 4, and FIGS. 5a to 6f, regarding the voltage applied to each phase, if voltage drop of the power semiconductor switch transistors is neglected, the time sections T1 and T2, at which effective voltage is applied, vary with the direction and the polarity of current. The medium phase current i_{mid} has two polarities corresponding to i_{mid}>0 and i_{mid}<0 with respect to a horizontal axis serving as a time axis.

Accordingly, time, at which effective voltage is actually applied, according to current paths in the 3-phase inverter and the magnitude of the effective voltage applied to each phase during the time are shown in table 1. Table 1 represents the effective voltage that is actually applied at each section according to the current paths.

TABLE 1

| | | | | | |
|---|---|---|---|---|---|
| section | t₀~t₂ | t₂~t₃ | t₃~t₁ | t₄~t₅ | t₅~t₀ |

| switching time | $\frac{1}{2} {T}_{o} + \frac{1}{2} {T}_{dead}$ | T₁ | T₂− T_{dead} | $\frac{1}{2} {T}_{o} + \frac{1}{2} {T}_{dead}$ |
|---|---|---|---|---|
| i_{mid} > 0 | vₘₐₓ = 0 v_{mid} = 0 vₘᵢₙ = 0 | $\begin{matrix}{v}_{max} = \frac{2}{3} \cdot {V}_{dc} \\ {v}_{mid} = - \frac{1}{3} \cdot {V}_{dc} \\ {v}_{min} = - \frac{1}{3} \cdot {V}_{dc}\end{matrix}$ | $\begin{matrix}{v}_{max} = \frac{1}{3} \cdot {V}_{dc} \\ {v}_{mid} = \frac{1}{3} \cdot {V}_{dc} \\ {v}_{min} = - \frac{2}{3} \cdot {V}_{dc}\end{matrix}$ | vₘₐₓ = 0 v_{mid} = 0 vₘᵢₙ = 0 |

| switching time | $\frac{1}{2} {T}_{o} + \frac{1}{2} {T}_{dead}$ | T₁ − T_{dead} | T₂ | $\frac{1}{2} {T}_{o} + \frac{1}{2} {T}_{dead}$ |
|---|---|---|---|---|
| i_{mid} < 0 | vₘₐₓ = 0 v_{mid} = 0 vₘᵢₙ = 0 | $\begin{matrix}{v}_{max} = \frac{2}{3} \cdot {V}_{dc} \\ {v}_{mid} = - \frac{1}{3} \cdot {V}_{dc} \\ {v}_{min} = - \frac{1}{3} \cdot {V}_{dc}\end{matrix}$ | $\begin{matrix}{v}_{max} = \frac{1}{3} \cdot {V}_{dc} \\ {v}_{mid} = \frac{1}{3} \cdot {V}_{dc} \\ {v}_{min} = - \frac{2}{3} \cdot {V}_{dc}\end{matrix}$ | vₘₐₓ = 0 v_{mid} = 0 vₘᵢₙ = 0 |

As shown in table 1, in the sections T₁ and T₂ at which the effective voltage is applied, time loss as dead-time occurs during the section T₂ if the medium phase current i_{mid}>0, and occurs during the section if the medium phase current i_{mid}<0.

In an ideal 3-phase inverter without the dead-time, each phase voltage during the sections T₁ and T₂, at which the effective voltage actually is applied, is expressed as equation 1.

$${V}_{max}^{*} = ( ( \frac{2}{3} \cdot {T}_{1} ) + ( \frac{1}{3} \cdot {T}_{2} ) ) \cdot \frac{{V}_{dc}}{{T}_{s}} \\ {V}_{mid}^{*} = ( ( - \frac{1}{3} \cdot {T}_{1} ) + ( \frac{1}{3} \cdot {T}_{2} ) ) \cdot \frac{{V}_{dc}}{{T}_{s}} \\ V {υ}_{max}^{*} = ( ( - \frac{1}{3} \cdot {T}_{1} ) + ( - \frac{2}{3} \cdot {T}_{2} ) ) \cdot \frac{{V}_{dc}}{{T}_{s}} \qquad Equation 1$$

When dead-time does not exist, each effective time is calculated by extracting the maximum phase command voltage Vₘₐₓ and the minimum phase command voltage Vₘᵢₙ* from the magnitudes of a command voltage, and the effective time is expressed as Equation 2.

$${T}_{1} = ( 2 \cdot {V}_{max}^{*} + {V}_{min}^{*} ) \cdot {T}_{s} \cdot \frac{1}{{V}_{dc}} \\ {T}_{2} = - ( {V}_{max}^{*} + 2 \cdot {V}_{min}^{*} ) \cdot {T}_{s} \cdot \frac{1}{{V}_{dc}} \\ {T}_{o} = {T}_{s} - {T}_{1} - {T}_{2} \qquad Equation 2$$

In other words, since the time to apply the effective voltage is not compensated for dead-time when dead-time does not exist, each effective time according to the polarity of the medium phase current i_{mid} is calculated from Equations 3 and 4 when the dead-time exists.

$$\begin{matrix}i mid > 0 \\ {V}_{max}^{*} = ( ( \frac{2}{3} \cdot {T}_{1} ) + ( \frac{1}{3} \cdot ( {T}_{2} - {T}_{dead} ) ) ) \cdot \frac{{V}_{dc}}{{T}_{s}} \\ {V}_{mid}^{*} = ( ( - \frac{1}{3} \cdot {T}_{1} ) + ( \frac{1}{3} \cdot ( {T}_{2} - {T}_{dead} ) ) ) \cdot \frac{{V}_{dc}}{{T}_{s}} \\ {V}_{min}^{*} = ( ( - \frac{1}{3} \cdot {T}_{1} ) + ( - \frac{2}{3} \cdot ( {T}_{2} - {T}_{dead} ) ) ) \cdot \frac{{V}_{dc}}{{T}_{s}} \\ {T}_{1} = ( 2 \cdot {V}_{max}^{*} + {V}_{min}^{*} ) \cdot {T}_{s} \cdot \frac{1}{{V}_{dc}} \\ {T}_{2} = - ( {V}_{max}^{*} + 2 \cdot {V}_{min}^{*} ) \cdot {T}_{s} \cdot \frac{1}{{V}_{dc}} + {T}_{dead} \\ {T}_{o} = {T}_{s} - {T}_{1} - {T}_{2} & Equation 3 \\ I mid < 0 \\ {V}_{max}^{*} = ( ( \frac{2}{3} \cdot ( {T}_{1} - {T}_{dead} ) ) + ( \frac{1}{3} \cdot {T}_{2} ) ) \cdot \frac{{V}_{dc}}{{T}_{s}} \\ {V}_{mid}^{*} = ( ( - \frac{1}{3} \cdot ( {T}_{1} - {T}_{dead} ) ) + ( \frac{1}{3} \cdot {T}_{2} ) ) \cdot \frac{{V}_{dc}}{{T}_{s}} \\ {V}_{min}^{*} = ( ( - \frac{1}{3} \cdot ( {T}_{1} - {T}_{dead} ) ) + ( - \frac{2}{3} \cdot {T}_{2} ) ) \cdot \frac{{V}_{dc}}{{T}_{s}} \\ {T}_{1} = ( 2 \cdot {V}_{max}^{*} + {V}_{min}^{*} ) \cdot {T}_{s} \cdot \frac{1}{{V}_{dc}} + {T}_{dead} \\ {T}_{2} = - ( {V}_{max}^{*} + 2 \cdot {V}_{min}^{*} ) \cdot {T}_{s} \cdot \frac{1}{{V}_{dc}} \\ {T}_{o} = {T}_{s} - {T}_{1} - {T}_{2} & Equation 4\end{matrix}$$

From Equations 3 and 4, effective voltage switching time can be simply compensated by using the maximum phase value and the minimum phase value extracted from command voltage of each phase according to the paths of the medium phase current i_{mid}. The real switch time of each phase is calculated from Equation 5.

$${T}_{max} = \frac{{T}_{0}}{2} + {T}_{1} + {T}_{2} \\ {T}_{mid} = \frac{{T}_{0}}{2} + {T}_{2} \\ {T}_{min} = \frac{{T}_{0}}{2} \qquad Equation 5$$

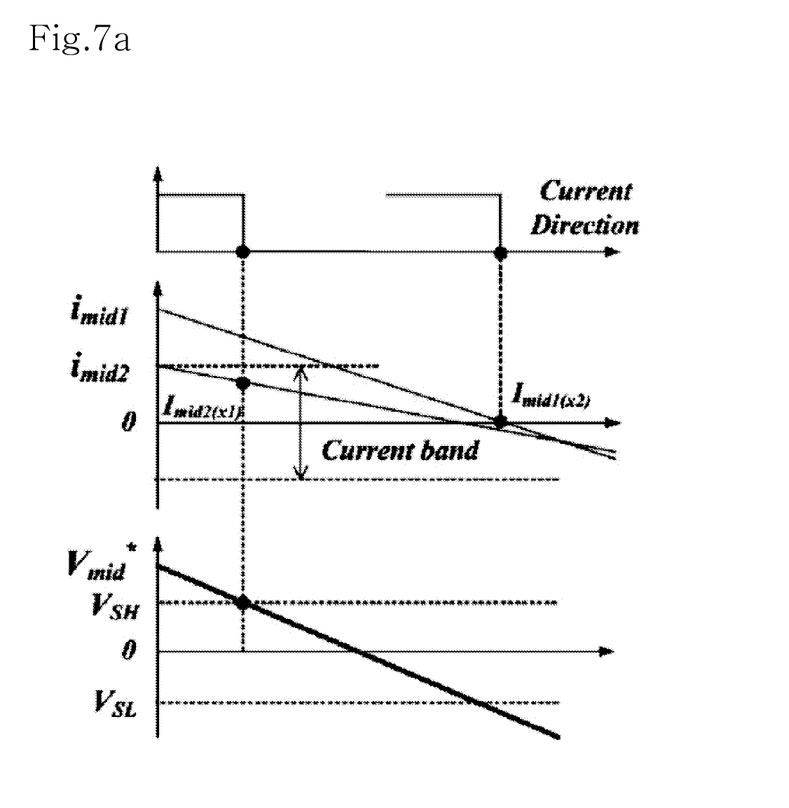

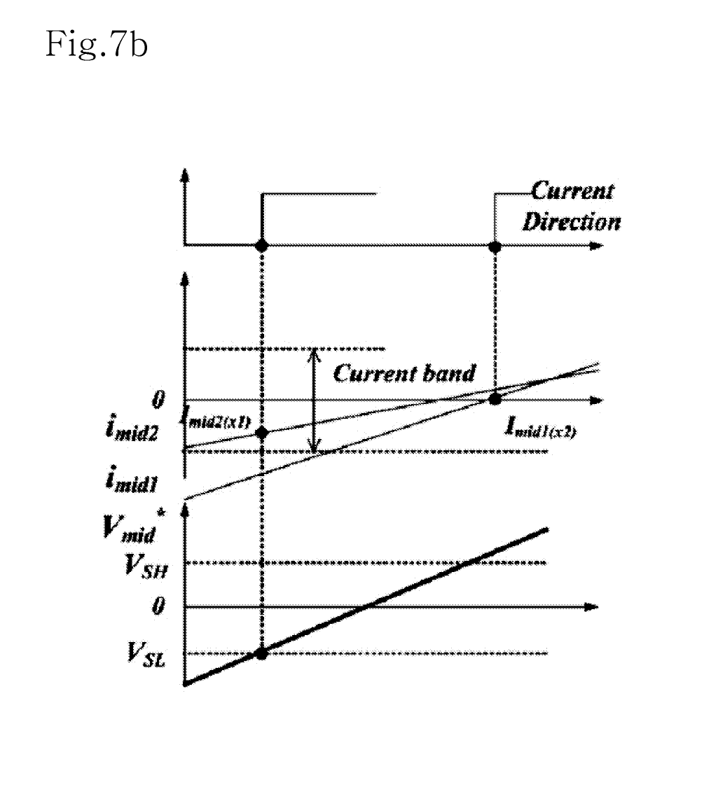

FIG. 7a is a graph showing a current direction in an alternating section of the medium phase current i_{mid} when the medium phase command voltage V_{mid}*>0, and FIG. 7b is a graph showing the current direction in the alternating section of the medium phase current i_{mid} when the medium phase command voltage V_{mid}*<0.

As shown in FIGS. 7a and 7b, errors may occur in the applied voltage according to the direction of the medium phase current during the compensation for the dead-time. Accordingly, the medium phase current i_{mid} is detected at a point where magnitudes V_{SL} and V_{SH} of the real medium command voltage are about 0.7V by taking the voltage drop of the power semiconductor switches into consideration. If the detected medium phase current i_{mid} is the second medium phase current i_{mid2} existing within fine current of 10 mA or less, even if current is not reversed actually, switching time is calculated on the assumption that the current has a negative direction based on the overlap of the time to apply the effective voltage. If the medium phase current i_{mid} is the first medium phase current i_{mid} exceeding the fine current of 10 mA, the switching time is normally calculated by taking into consideration the direction of the medium phase current, so that an influence is minimized at a section where effective time is overlapped with the dead-time.

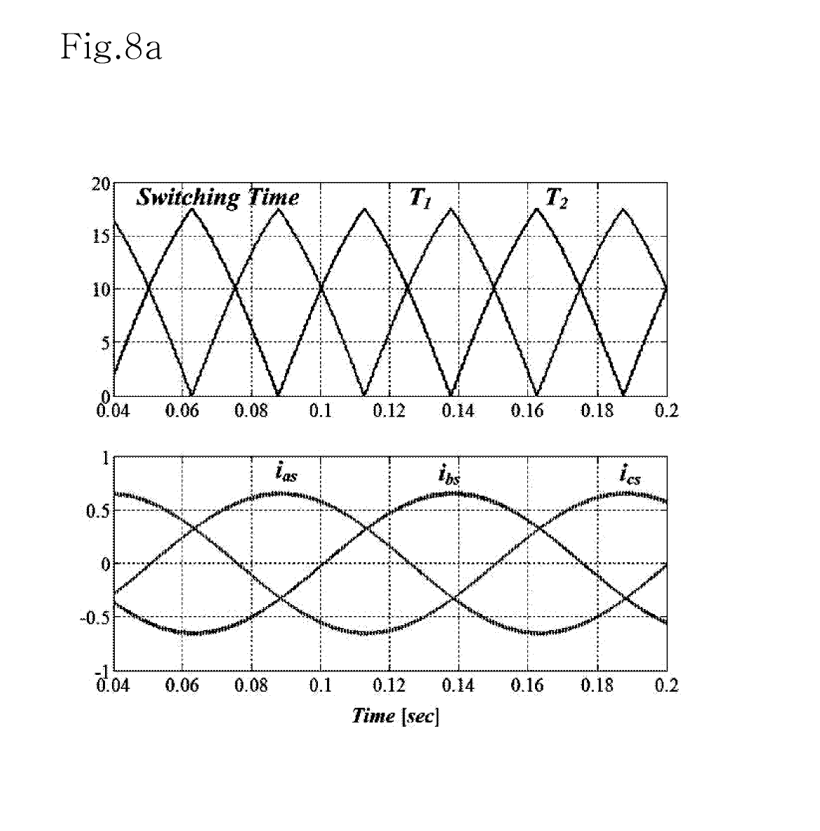

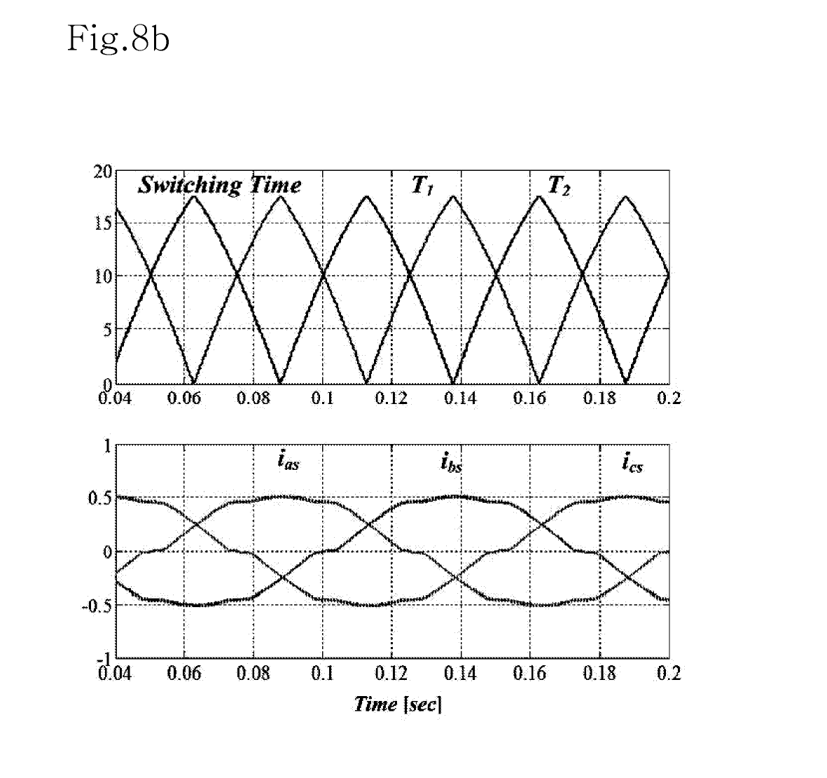

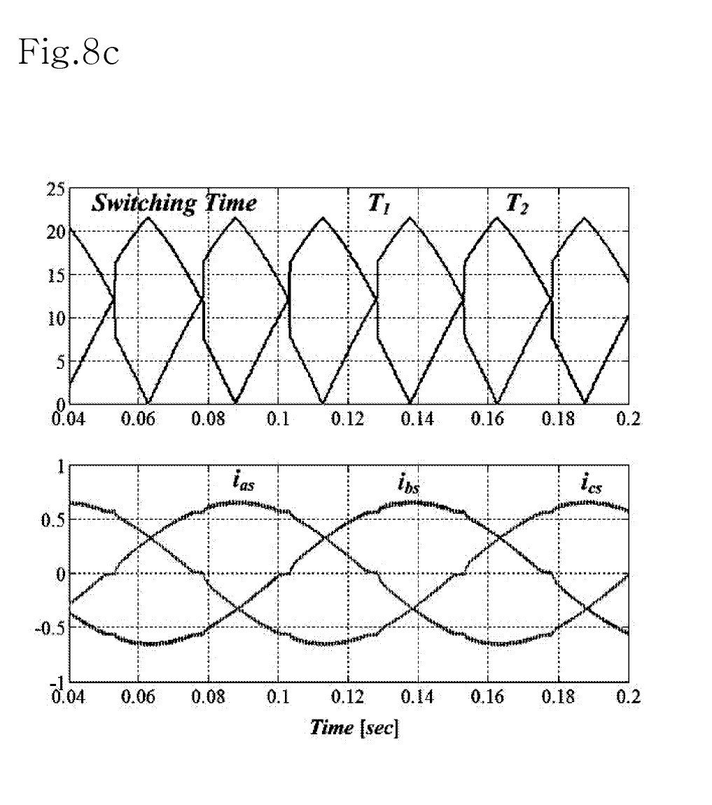

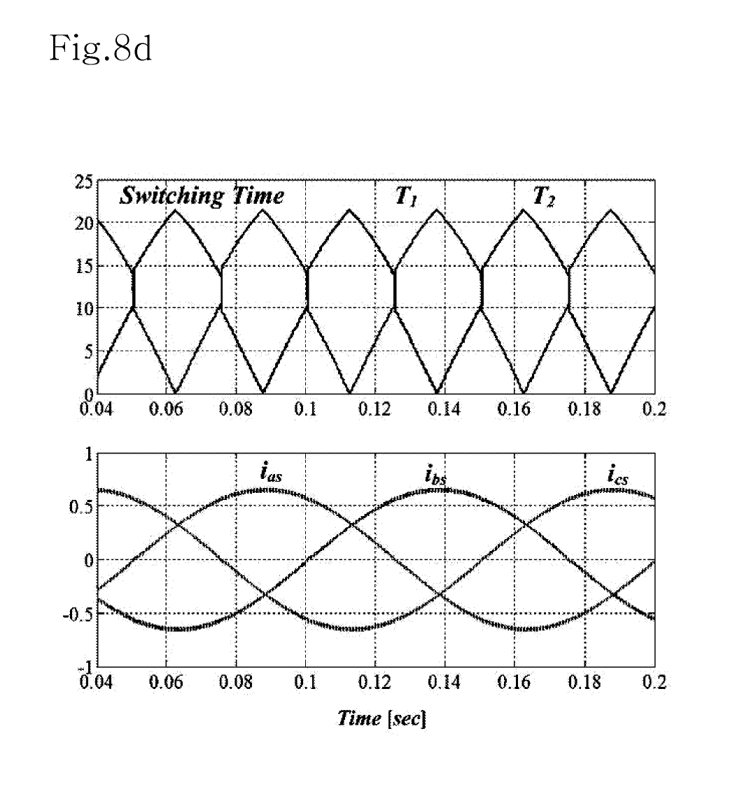

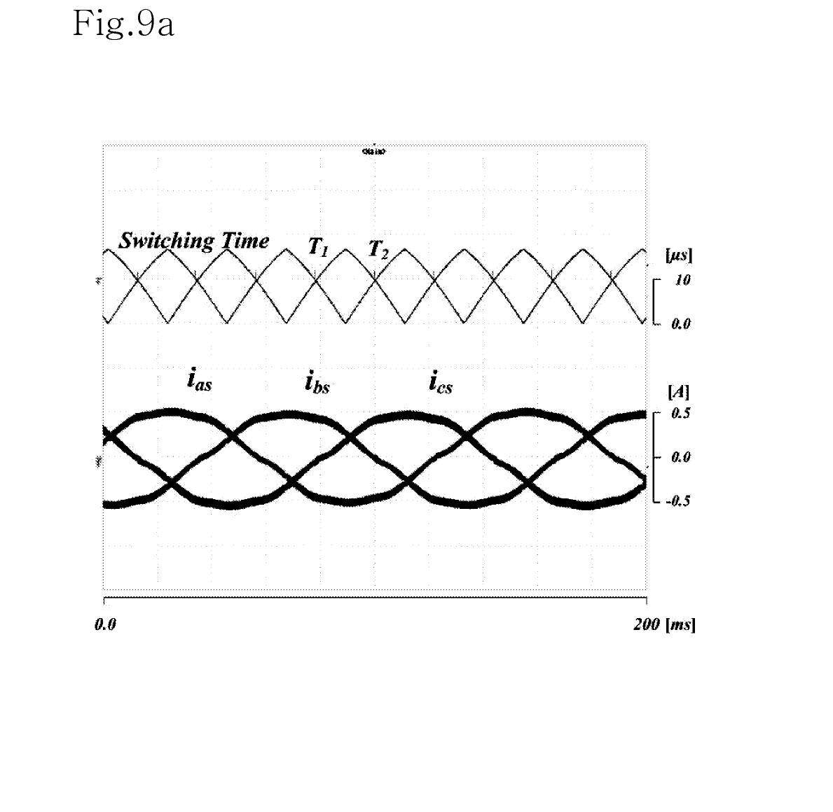

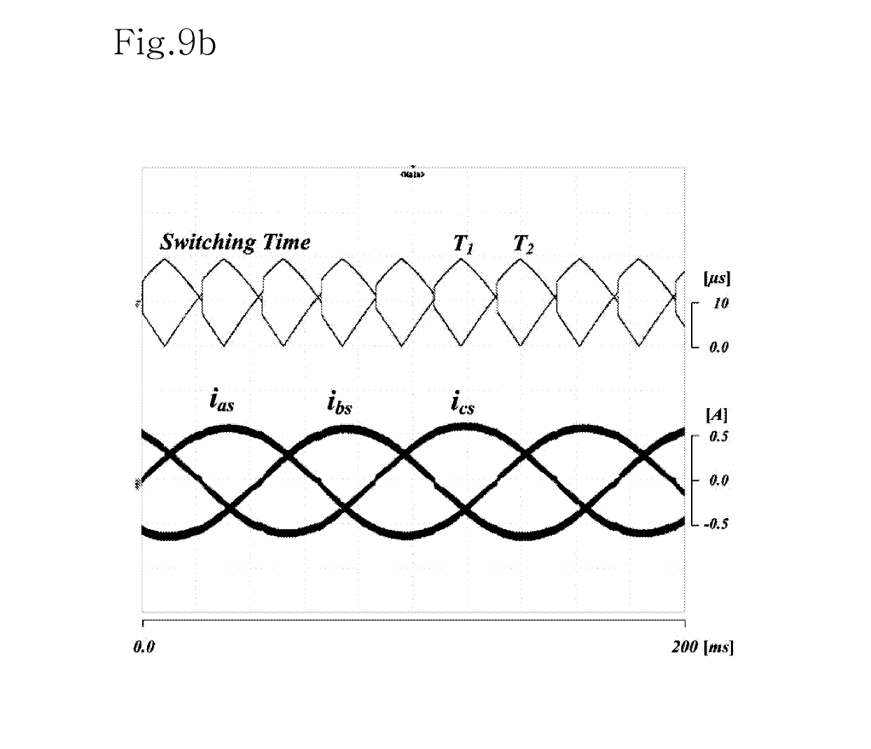

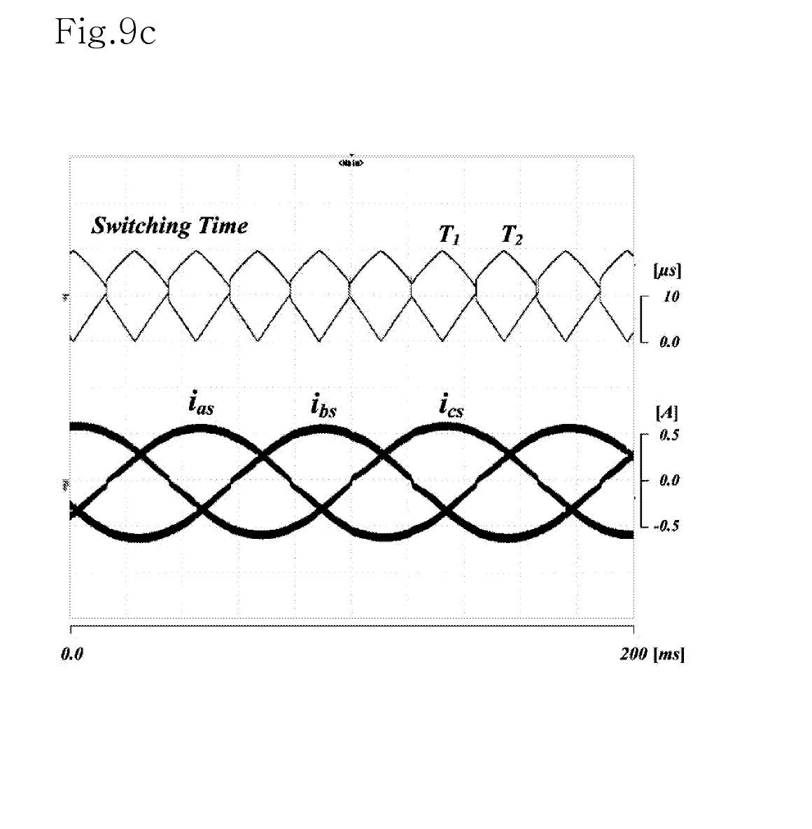

FIGS. 8a to 8d are views showing a simulation result according to the SVPWM scheme based on the current direction according to the present invention, and FIGS. 9a to 9c are views showing a simulation result according to the SVPWM scheme based on the current direction according to the present invention.

As shown in FIGS. 8a to 9c, sinusoidal load current is represented, and output voltage compensation can be effectively achieved when the current direction based on a current range is taken into account in the alternating section of the direction of the medium phase current of the load current.

A dead-time compensation algorithm of a 3-phase inverter using an SVPWM scheme according to the present invention is applicable for the control of an electric motor.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A dead-time compensation method of a 3-phase inverter using an SVPWM scheme and having upper and lower arms including power semiconductor switches, the dead-time compensation method comprising:
generating a switching signal having dead-time with respect to the power semiconductor switches of the upper and lower arms in order to obtain a predetermined output through the SVPWM scheme;
detecting medium phase current from each phase current output through the switching signal;
determining polarity of the medium phase current; and
generating a switching signal by calculating switching time in order to compensate for time to apply effective voltage according to the polarity of the medium phase current.

2. The dead-time compensation method of claim 1, wherein, in the determining the polarity of the medium phase current, a current magnitude range is set at a point at which a magnitude of a medium phase command voltage becomes lower than a degree of voltage drop occurring in the power semiconductor switch or an inverse diode, a normal direction of the medium phase current is detected if a magnitude of the medium phase current exceeds the current magnitude range, and a direction of the medium phase current is reversed at a prior time point if the magnitude of the medium phase current is within the current magnitude range, so that an influence is minimized at a section where effective time is overlapped with dead-time.

3. The dead-time compensation method of claim 2, wherein an effective voltage switching time is compensated by using a maximum phase value and a minimum phase value from command voltage of each phase according to a path of the medium phase current.
